(19) United States
(12) Patent Application Publication
(10) Pub. No.: US 2008/0187294 A1
(43) Pub. Date: Aug. 7, 2008

(54) Playback apparatus, playback method, and program

(75) Inventor: Arito Kobayashi, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/012,245

(22) Filed: Feb. 1, 2008

(30) Foreign Application Priority Data
Feb. 2, 2007 (JP) P2007-023775

(51) Int. Cl. H04N 7/26

(52) U.S. Cl. 386/124

(57) ABSTRACT

A playback apparatus plays back content according to a predetermined playback order by sequentially selecting chapters. The playback apparatus includes a checking unit configured to check, according to a user's operation specifying, as a new playback target, a chapter in either a backward direction or a forward direction of a current chapter, whether the specified chapter exists in content including the current chapter; a first determining unit configured to determine, as a new playback target, the specified chapter if the specified chapter exists in the content including the current chapter; and a second determining unit configured to determine, as a new playback target, a chapter included in content corresponding to the specified chapter among content to be played back according to the playback order before or after the content including the current chapter, if the specified chapter does not exist in the content including the current chapter.

### CROSS REFERENCES TO RELATED APPLICATIONS

The present invention contains subject matter related to Japanese Patent Application JP 2007-023775 filed in the Japanese Patent Office on Feb. 2, 2007, the entire contents of which are incorporated herein by reference.

### BACKGROUND OF THE INVENTION

1. Field of the Invention

The present invention relates to playback apparatuses, playback methods, and programs. More specifically, the present invention relates to a playback apparatus, a playback method, and a program with which the burden of operations can be reduced.

2. Description of the Related Art

In related art, as playback apparatuses that play back content, such as moving pictures (including sounds accompanying images as needed), still pictures, sounds (e.g., music), there exist, for example, network media players that play back content distributed from a server connected via a network, hard disk recorders (players) that play back content read from an internal hard disk, and so forth.

Content that is played back by such a playback apparatus are divided into a plurality of chapters. The playback apparatus plays back sequentially plays back chapters of content selected as playback targets so that, for example, a moving picture of the content is displayed on a display. Furthermore, if a user performs an operation to instruct playback of a next chapter (hereinafter referred to as a chapter forwarding operation when appropriate) when the playback apparatus is playing back a chapter, the playback apparatus skips playback of the chapter currently being played back and plays back the next chapter.

Let it be supposed that the user performs the chapter forwarding operation repeatedly, and further performs the chapter forwarding operation when the playback apparatus is playing back the last chapter of content serving as a playback target. In this case, a chapter next to the chapter currently being played back does not exist, so that it is not possible to play back a next chapter. Thus, a message indicating that the chapter forwarding operation is not allowed is displayed on the display.

In response to the message, in order to play back next content, the user has to perform an operation to stop playback of the content currently being played back, display a list of content that can be played back by the playback apparatus, and select content that is to be selected as a next playback target from the content list. That is, the user is not allowed to play back next content without performing such a laborious operation.

In a playback apparatus that is described, for example, in Japanese Unexamined Patent Application Publication No. 2006-338722, a sub-playback window in which a chapter including a desired scene is played back by fast-forwarding is displayed on a display, and if an operation for starting normal playback is performed when the desired scene is played back by fast-forwarding in the sub-playback window, content is played back from the desired scene.

### SUMMARY OF THE INVENTION

As described above, in the playback apparatus according to the related art, if the user performs a chapter forwarding operation when the last chapter of content is being played back, next chapter is not played back. Thus, flexibility of operation for the user is low. In order to play back next content, the user has to perform laborious operations, which bother the user wishing to view content sequentially.

It is desired that the burden of operations can be reduced.

According to an embodiment of the present invention, there is provided a playback apparatus that plays back a plurality of pieces of content according to a predetermined playback order by sequentially selecting chapters included in the plurality of pieces of content as playback targets. The playback apparatus includes checking means for checking, according to an operation by a user specifying, as a new playback target, a chapter in either a backward direction or a forward direction of a chapter currently selected as a playback target, whether the chapter specified by the user exists in a piece of content including the chapter currently selected as the playback target; first determining means for determining, as a new playback target, the chapter specified by the user if it is determined that the chapter specified by the user exists in the piece of content including the chapter currently selected as the playback target; and second determining means for determining, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

According to another embodiment of the present invention, there is provided a playback method of playing back a plurality of pieces of content according to a predetermined playback order by sequentially selecting chapters included in the plurality of pieces of content as playback targets, or a program for causing a computer to execute processing for playing back a plurality of pieces of content according to a predetermined playback order by sequentially selecting chapters included in the plurality of pieces of content as playback targets. The playback method or processing includes the steps of checking, according to an operation by a user specifying, as a new playback target, a chapter in either a backward direction or a forward direction of a chapter currently selected as a playback target, whether the chapter specified by the user exists in a piece of content including the chapter currently selected as the playback target; determining, as a new playback target, the chapter specified by the user if it is determined that the chapter specified by the user exists in the piece of content including the chapter currently selected as the playback target; and determining, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

According to these embodiments of the present invention, it is checked, according to an operation by a user specifying, as a new playback target, a chapter in either a backward direction or a forward direction of a chapter currently selected as a playback target, whether the chapter specified by the user exists in a piece of content including the chapter currently selected as the playback target. If it is determined that the chapter specified by the user exists in the piece of content including the chapter currently selected as the playback target, the chapter specified by the user is determined as a new playback target. On the other hand, if it is determined that the chapter specified by the user does not exist in the piece of content including the chapter currently selected as the playback target, a chapter included in a piece of content corresponding to the chapter specified by the user among pieces of content that are to be played back according to the playback order before or after the piece of content including the chapter currently selected as the playback target is determined as a new playback target.

According to these embodiments of the present invention, the burden of operations can be reduced.

### BRIEF DESCRIPTION OF THE DRAWINGS

FIG. 1 is a block diagram showing an example configuration of a digital television receiver according to an embodiment of the present invention;

FIG. 2 is a flowchart for explaining a process in which a chapter before or next to a current chapter is selected as a playback target according to a user's operation;

FIG. 3 is a flowchart for explaining a chapter forwarding process;

FIG. 4 is a flowchart for explaining a chapter reversing process;

FIG. 5 is a diagram for explaining control of playback of content according to user's operations;

FIG. 6 is a diagram for explaining control of playback of content according to user's operations;

FIG. 7 is a diagram showing an example of processing for content divided into chapters and content not divided into chapters; and

FIG. 8 is a diagram showing an example screen that is displayed on a display.

### DESCRIPTION OF THE PREFERRED EMBODIMENTS

Before describing embodiments of the present invention, examples of correspondence between the features of the present invention and embodiments described in the specification or shown in the drawings will be described below. This description is intended to assure that embodiments supporting the present invention are described in this specification or shown in the drawings. Thus, even if a certain embodiment is not described in this specification or shown in the drawings as corresponding to certain features of the present invention, that does not necessarily mean that the embodiment does not correspond to those features. Conversely, even if an embodiment is described or shown as corresponding to certain features, that does not necessarily mean that the embodiment does not correspond to other features.

A playback apparatus according to an embodiment of the present invention is a playback apparatus that plays back a plurality of pieces of content according to a predetermined playback order by sequentially selecting chapters included in the plurality of pieces of content as playback targets. The playback apparatus includes:

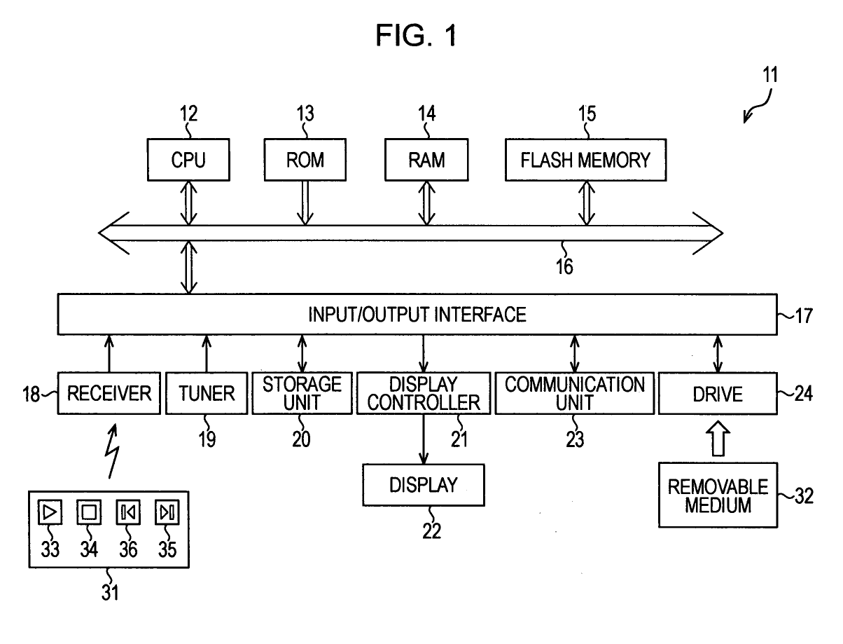

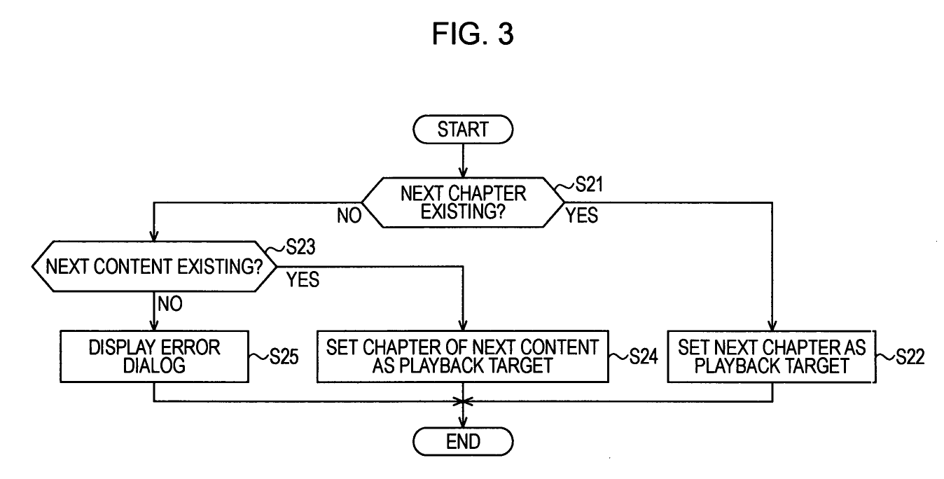

checking means (e.g., a CPU 12, shown in FIG. 1, which executes step S21 shown in FIG. 3) for checking, according to an operation by a user specifying, as a new playback target, a chapter in either a backward direction or a forward direction of a chapter currently selected as a playback target, whether the chapter specified by the user exists in a piece of content including the chapter currently selected as the playback target;

first determining means (e.g., the CPU 12, shown in FIG. 1, which executes step S22 shown in FIG. 3) for determining, as a new playback target, the chapter specified by the user if it is determined that the chapter specified by the user exists in the piece of content including the chapter currently selected as the playback target; and

second determining means (e.g., the CPU 12, shown in FIG. 1, which executes step S24 shown in FIG. 3) for determining, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

The playback apparatus may further include:

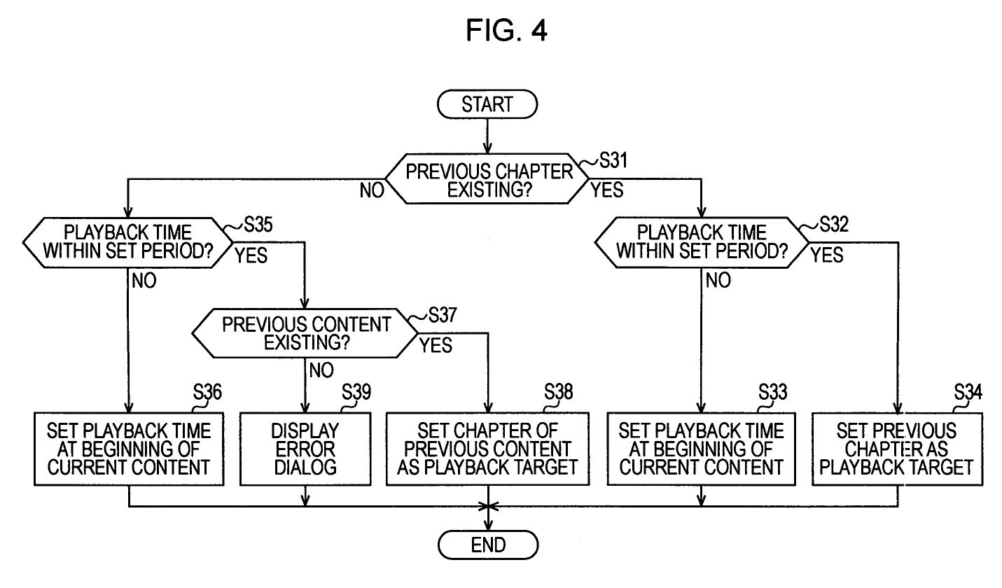

playback-time checking means (e.g., the CPU 12, shown in FIG. 1, which executes step S32 or S35 shown in FIG. 4) for checking, according to a user's operation specifying, as a new playback target, a chapter in the backward direction of the chapter currently selected as the playback target, whether a playback time in the chapter currently selected as the playback target is a time after elapse of a predetermined set period from a playback start time of the chapter; and

playback-time shifting means (e.g., the CPU 12, shown in FIG. 1, which executes step S33 or S36 shown in FIG. 4) for shifting the playback time in the chapter currently selected as the playback target to the playback start time of the chapter if it is determined that the playback time is a time after elapse of the predetermined set period from the playback start time of the chapter.

A playback method or a program according to an embodiment of the present invention is a playback method of playing back a plurality of pieces of content according to a predetermined playback order by sequentially selecting chapters included in the plurality of pieces of content as playback targets, or a program for causing a computer to execute processing for playing back a plurality of pieces of content according to a predetermined playback order by sequentially selecting chapters included in the plurality of pieces of content as playback targets. The playback method or the processing includes the steps of:

checking (e.g., step S21 shown in FIG. 3), according to an operation by a user specifying, as a new playback target, a chapter in either a backward direction or a forward direction of a chapter currently selected as a playback target, whether the chapter specified by the user exists in a piece of content including the chapter currently selected as the playback target;

determining (e.g., step S22 shown in FIG. 3), as a new playback target, the chapter specified by the user if it is determined that the chapter specified by the user exists in the piece of content including the chapter currently selected as the playback target; and

determining (e.g., step S24 shown in FIG. 3), as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

Now, embodiments of the present invention will be described in detail with reference to the drawings.

FIG. 1 is a block diagram showing an example configuration of a digital television receiver (DTV) according to an embodiment of the present invention.

Referring to FIG. 1, a DTV 11 includes a central processing unit (CPU) 12, a read-only memory (ROM) 13, a random access memory (RAM) 14, a flash memory (e.g., an electronically erasable and programmable read-only memory (EEPROM)) 15, a bus 16, an input/output interface 17, a receiver 18, a tuner 19, a storage unit 20, a display controller 21, a display 22, a communication unit 23, and a drive 24.

The CPU 12, the ROM 13, the RAM 14, and the flash memory 15 are connected to each other via the bus 16, and the input/output interface 17 is also connected to the bus 16. In addition to the bus 16, the input/output interface 17 is connected to the receiver 18, the tuner 19, the storage unit 20, the display controller 21, the communication unit 23, and the drive 24.

The CPU 12 reads programs stored in the ROM 13 or the flash memory 15 via the bus 16, and executes the programs, thereby controlling the blocks of the DTV 11 via the bus 16 or the input/output interface 17.

The ROM 13 stores programs that are executed by the CPU 12, and so forth. The RAM 14 temporarily stores programs executed by the CPU 12, data used for operation of the CPU 12, and so forth. The flash memory 15 stores programs executed by the CPU 12, and data that is to be maintained even when, for example, the DTV 11 is powered off.

The receiver 18 receives an operation signal sent from a remote commander 31. More specifically, the remote commander 31 is configured to send an operation signal corresponding to an operation performed by a user, and the receiver 18 receives the operation signal sent from the remote commander 31 as described above, and supplies the operation signal to the CPU 12 via the input/output interface 17 ad the bus 16.

The tuner 19 receives broadcasting signals of digital broadcasting, received by an antenna (not shown). Under the control of the CPU 12, the tuner 19 demodulates broadcasting signals of a desired channel from broadcasting signals supplied thereto, and supplies image data obtained as a result of demodulation to the display controller 21 via the input/output interface 17.

The storage unit 20 is formed of, for example, a hard disk drive or the like. For example, the storage unit 20 stores content including image data, audio data, text data, or other data or the like. Under the control of the CPU 12, the storage unit 20 supplies image data included in content that is to be played back to the display controller 21.

The content stored in the storage unit 20 has meta-information, which is information relating to the content, recorded at the beginning thereof. For example, if the content is divided into a plurality of chapters, playback start times, lengths (playback periods), and so forth of the individual chapters are recorded as meta-information. The CPU 12 reads meta-information of content selected as a playback target from the storage unit 20, and controls playback of the content according to the meta-information.

The display controller 21 controls display of an image on the display 22 under the control of the CPU 12. For example, upon receiving data of an image from the storage unit 20, the display controller 21 causes the display 22 to display the image. Furthermore, the display controller 21 causes the display 22 to on-screen display (OSD) a message to the user, a list of pieces of content stored in the storage unit 20, and so forth.

The display 22 is formed of, for example, a cathode ray tube (CRT) display or a liquid crystal display (LCD), and displays an image under the control of the display controller 21.

The communication unit 23 is formed of, for example, a modem, a terminal adaptor, or other types of communication interface or the like. The communication unit 23 performs communication via various types of network (not shown), such as the Internet, a local area network (LAN), a telephone circuit, or a cable television (CATV) network.

On the drive 24, a removable medium 32, such as a magnetic disc, an optical disc, a magneto-optical disc, or a semiconductor memory, is loaded as needed. The drive 24 reads data recorded on the removable medium 32, or records data on the removable medium 32 as needed.

For example, let it be supposed that the removable medium 32 having recorded thereon content including image data is loaded on the drive 24 and that the user performs an operation for instructing playback of the content recorded on the removable medium 32. In this case, under the control of the CPU 12, the drive 24 reads the data of the image recorded on the removable medium 32, and supplies the data of the image read from the removable medium 32 to the display controller 21 via the input/output interface 17.

The remote commander 31 is operated by the user when the DTV 11 is remote-controlled, and sends an operation signal corresponding to the user's operation to the receiver 18, for example, by wireless using infrared rays, electromagnetic waves, or the like. The remote commander 31 has buttons, a joystick, or the like for operation by the user.

Referring to FIG. 1, the remote commander 31 has a playback/pause button 33 that is operated to instruct playback or pausing of playback of content, a stop button 34 that is operated to instruct stopping of content that is being played back, a chapter forwarding button 35 that is operated to instruct playback of a chapter that is next to (in the forward direction of) a chapter currently selected as a playback target, a chapter reversing button 36 that is operated to instruct playback of a chapter before (in the backward direction of) the chapter currently selected as the playback target, and so forth.

In the DTV 11 configured as described above, when the user specifies a piece of content stored in the storage unit 20 and operates the playback/pause button 33 of the remote commander 31, playback of the content is started. Furthermore, if the user operates the playback/pause button 33 of the remote commander 31 while the content is being played back, the ongoing playback of the content is paused. Hereinafter, content that is being played back or content whose playback is currently paused is referred to as current content when appropriate, and a chapter serving as a playback target in the current content will be referred to as a current chapter when appropriate.

If the user operates the chapter forwarding button 35 of the remote commander 31 while content is being played back or playback of content is currently paused, in the DTV 11, a chapter next to the current chapter is selected as a playback target. Furthermore, if the user repeatedly operates the chapter forwarding button 35, chapters constituting the current content are sequentially selected as playback targets. If the user operates the chapter forwarding button 35 while the last chapter of the current content is serving as a playback target, a chapter at the beginning of content next to the current content is selected as a playback target.

For example, regarding pieces of content stored in the storage unit 20, a playback order for playing back the pieces of content is set according to, for example, dates and times of recording of the pieces of content. The storage unit 20 stores a playback order list in which the pieces of content are associated with the playback order of the pieces of content. If the user operates the chapter forwarding button 35 when the last chapter of the current content is serving as a playback target, the CPU 12 reads from the storage unit 20 content that is to be played back next to the current content according to the playback order list, and plays back the content that has been read.

On the other hand, if the user operates the chapter reversing button 36, in the DTV 11, a chapter before the current chapter is selected as a playback target. If the user operates the chapter reversing button 36 when the first chapter of the current content is serving as a playback target, a chapter at the beginning of content before the current content is selected as a playback target.

As described above, in the DTV 11, a chapter before or next to the current chapter is selected as a playback target.

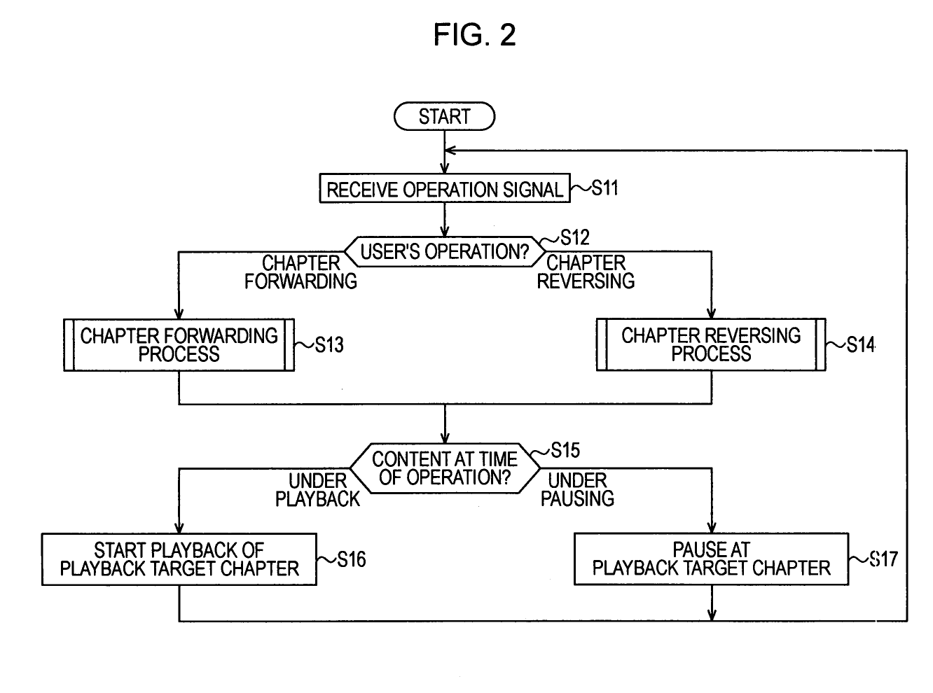

FIG. 2 is a flowchart for explaining a process in which the DTV 11 shown in FIG. 1 selects a chapter before or next to the current chapter as a playback target according to a user's operation.

If the user operates the chapter forwarding button 35 or the chapter reversing button 36 while content is being played back or playback of content is paused, the remote commander 31 sends an operation signal corresponding to the user's operation. Then, in step S11, the receiver 18 receives the operation signal sent from the remote commander 31, and supplies the operation signal to the CPU 12.

After step S11, the process proceeds to step S12. In step S12, on the basis of the operation signal received by the receiver 18 in step S11, the CPU 12 determines whether the user's operation is a chapter forwarding operation that instructs playback of a chapter next to the current chapter or a chapter reversing operation that instructs playback of a chapter before the current chapter.

If the CPU 12 determines in step S12 that the user's operation is a chapter forwarding operation, the process proceeds to step S13. In step S13, the CPU 12 executes a chapter forwarding process to set a chapter next to the current chapter as a playback target.

On the other hand, if the CPU 12 determines in step S12 that the user's operation is a chapter reversing operation, the process proceeds to step S14. In step S14, the CPU 12 executes a chapter reversing process to set a chapter before the current chapter as a playback target.

After step S13 or S14, the process proceeds to step S15. In step S15, the CPU 12 checks whether content was being played back or playback of content was paused at the time of reception of the operation signal corresponding to the user's operation by the receiver 18 in step S11, i.e., at the time when the user performed the chapter forwarding operation or chapter reversing operation.

If the CPU 12 determines in step S15 that content was being played back at the time of reception of the operation signal corresponding to the user's operation by the receiver 18, the process proceeds to step S16. In step S16, the CPU 12 controls the storage unit 20 and the display controller 21 so that playback of the current chapter is stopped and playback of the chapter selected as a playback target in step S13 or S14 is started. That is, the storage unit 20 supplies data of an image of the chapter selected as the playback target to the display controller 21 under the control of the CPU 12, and the display controller 21 starts playback of the data of the image supplied from the storage unit 20 so that the image is displayed on the display 22.

On the other hand, if the CPU 12 determines in step S15 that playback of content was paused at the time of reception of the operation signal corresponding to the user's operation by the receiver 18, the process proceeds to step S17. In step S17, the CPU 12 controls the storage unit 20 and the display controller 21 so that playback is paused at the chapter selected as a playback target in step S13 or S14. That is, the storage unit 20 supplies data of an image at the beginning of the chapter selected as a playback target to the display controller 21 under the control of the CPU 12, and the display controller 21 plays back the data of the image supplied from the storage unit 20 so that the image (still image) is displayed on the display 22.

After step S16 or S17, the process returns to step S11, and the subsequent processing steps are repeated similarly.

Next, FIG. 3 is a flowchart for explaining the chapter forwarding process in step S13 shown in FIG. 2.

In step S21, on the basis of meta-information of current content, stored in the storage unit 20, the CPU 12 checks whether a chapter next to the current chapter exists in the current content.

If the CPU 12 determines in step S21 that a chapter next to the current chapter exists in the current content, the process proceed to step S22. In step S22, the CPU 12 sets the chapter next to the current chapter as a playback target.

On the other hand, if the CPU 12 determines in step S21 that a chapter next to the current chapter does not exist in the current content, i.e., if the current chanter is the last chapter of the current content, the process proceeds to step S23.

In step S23, the CPU 12 checks whether content next to the current content exists, i.e., whether content that is to be played back next to the current content exists in the playback order list stored in the storage unit 20.

If the CPU 12 determines in step S23 that content next to the current content exists, the process proceeds to step S24. In step S24, the CPU 12 selects a chapter at the beginning of the content next to the current content as a playback target. Furthermore, in order to let the user recognize that content that serves as a playback target has been changed from the current content to the next content, the CPU 12 controls the display controller 21 so that a title of the content newly selected as a playback target is displayed on the display 22.

On the other hand, if the CPU 12 determines in step S23 that content next to the current content does not exist, i.e., if the current content is the last content according to the playback order, the process proceeds to step S25.

In step S25, the CPU 12 controls the display controller 21 so that an error dialog is displayed on the display 22, the error dialog showing a message indicating that chapter forwarding is not allowed since content next to the current content does not exist. In this case, the playback target chapter remains to be the current chapter.

After step S22, S24, or S25, the chapter forwarding process comes to an end.

FIG. 4 is a flowchart for explaining the chapter reversing process in step S14 shown in FIG. 2.

In step S31, on the basis of the meta-information of the current content, stored in the storage unit 20, the CPU 12 checks whether a chapter before the current chapter exists in the current content.

If the CPU 12 determines in step S31 that a chapter before the current chapter exists in the current content, the process proceeds to step S32. In step S32, the CPU 12 checks whether the playback time of the current chapter is within a set period from the playback start time of the current chapter. The playback time indicates a time at which an image currently displayed on the display 22 is played back with reference to a time at which playback of the chapter is started (time at the beginning of the chapter), and the set period is predetermined to be, for example, 3 seconds.

If the CPU 12 determines in step S32 that the playback time of the current chapter is not within the set period from the playback start time of the current chapter (i.e., the playback time is a time after elapse of the set period), the process proceeds to step S33. In step S33, the CPU 12 sets the playback time to be the playback start time of the current chapter. Thus, in this case, the playback target chapter remains to be the current chapter.

On the other hand, if the CPU 12 determines in step S32 that the playback time of the current chapter is within the set period from the playback start time of the current chapter, the process proceeds to step S34. In step S34, the CPU 12 selects the chapter before the current chapter as a playback target.

If the CPU 12 determines in step S31 that a chapter before the current chapter does not exist in the current content, the process proceeds to step S35. In step S35, similarly to step S32, the CPU 12 checks whether the playback time of the current chapter is within the set period from the playback start time of the current chapter.

If the CPU 12 determines in step S35 that the playback time of the current chapter is not within the set period from the playback start time of the current chapter, the process proceeds to step S36. In step S36, the CPU 12 sets the playback time to be the playback start time of the current chapter. Thus, in this case, the playback target chapter remains to be the current chapter.

On the other hand, if the CPU 12 determines in step S35 that the playback time of the current chapter is within the set period from the playback start time of the current chapter, the process proceeds to step S37. In step S37, the CPU 12 checks whether content before the current content exists, i.e., whether content that is to be played back before the current content exists in the playback order list stored in the storage unit 20.

If the CPU 12 determines in step S37 that content before the current content exists, the process proceeds to step S38. In step S38, the CPU 12 selects a chapter at the beginning of the content before the current content as a playback target.

On the other hand, if the CPU 12 determines in step S37 that content before the current content does not exist, the process proceeds to step S39. In step S39, the CPU 12 controls the display controller 21 so that an error dialog is displayed on the display 22, the error dialog indicating that chapter reversing is not allowed since content before the current content does not exist. In this case, the playback target chapter remains to be the current chapter.

After step S33, S34, S36, S38, or S39, the chapter reversing process comes to an end.

In FIG. 4, it is checked whether a chapter before a current chapter exists in current content (step S31), and then it is checked whether the playback time of the current chapter is within a set period from the playback start time of the current chapter (step S32 or step S35). Alternatively, it is possible to check first whether the playback time of the current chapter is within a set period from the playback start time of the current chapter and then check whether a chapter before the current chapter exists in current content.

As described above, if the current chapter is the last chapter of the current content when a chapter forwarding operation is performed by the user, the first chapter of the content next to the current content is played back. On the other hand, if the current chapter is the first chapter of the current content when a chapter reversing operation is performed by the user, the first chapter of the content before the current content is played back.

Thus, for example, when the current chapter is the last chapter of the current content, the user can play back content sequentially without performing an operation to stop playback of the current content and specify next content in order to play back the next content. As described above, in the DTV 11, the burden of user's operations can be reduced.

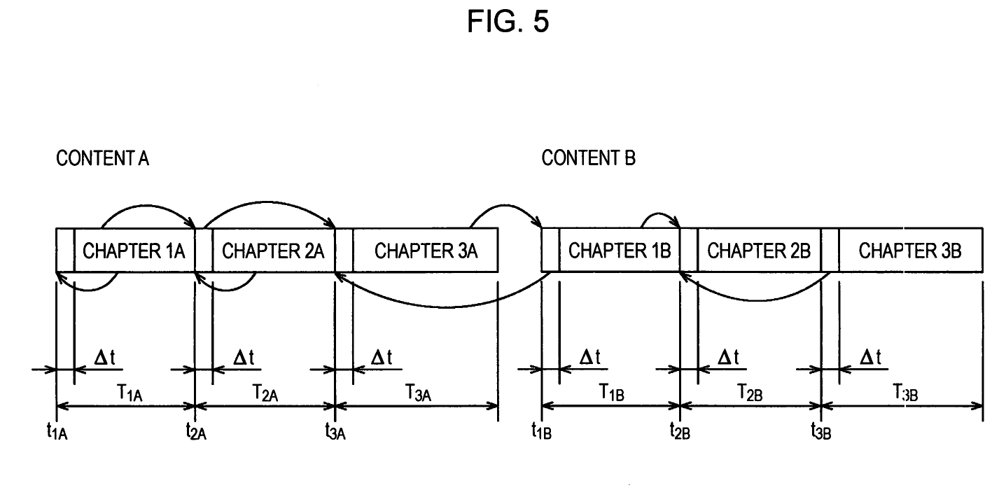

Next, control of playback of content according to user's operations will be described with reference to FIG. 5.

In FIG. 5, content A and content B serve as playback targets. As shown in FIG. 5, the content A is composed of three chapters 1A to 3A, and the content B is composed of three chapters 1B to 3B. The playback order is set so that the content A is first played back and the content B is then played back, and a set period Δt is set for each of the chapters 1A to 3A and 1B to 3B.

The playback start time of the chapter 1A is a start time t_{1A}, and the period during which the chapter 1A is played back is a playback period T_{1A}. Similarly to the chapter 1A the playback start times of the chapters 2A and 3A are a start time t_{2A} and a start time t_{3A}, respectively, and periods during which the chapter 2A and the chapter 3A are played back are a playback period T_{2A} and a playback period T_{3A}, respectively. Furthermore, playback start times of the chapters 1B, 2B, and 3B are playback start times t_{1B}, t_{2B}, and t_{3B}, respectively, and periods during which the chapters 1B, 2B, and 3B are played back are playback periods T_{1B}, T_{2B}, and T_{3B}, respectively.

Let it be supposed that while the DTV 11 is playing back the chapter 1A of the content A according to a user's operation, for example, the user presses the chapter forwarding button 35 shown in FIG. 1 when the playback time is in the playback period T_{1A} of the chapter 1A. In this case, the chapter 2A exists next to the chapter 1A, so that the CPU 12 determines that a chapter next to the current chapter exists in the current content (step S21 in FIG. 3). Then, the CPU 12 selects the chapter 2A as a playback target (step S22 in FIG. 3), and starts playback from the start time t_{2A} of the chapter 2A.

Similarly to the case where the playback time is in the playback period T_{1A} of the chapter 1A, if the user operates the chapter forwarding button 35 when the playback time is in the playback period T_{2A} of the chapter 2A, playback is started from the start time t_{3A} of the chapter 3A.

If the user operates the chapter forwarding button 35 when the playback time is in the playback period T_{3A} of the chapter 3A, since no chapter of the content A exists next to the chapter 3A, the CPU 12 determines that a chapter next to the current chapter does not exist in the current content (step S21 in FIG. 3). Furthermore, since the content B exists, which is to be played back next to the content A, the CPU 12 determines that content next to the current content exists (step S23 in FIG. 3), selects the chapter 1B of the content B as a playback target (step S24 in FIG. 3), and starts playback from the start time t_{1B} of the chapter 1B.

As another example, let it be supposed that the user operates the chapter reversing button 36 shown in FIG. 1 when the playback time is in the playback period T_{3B} of the chapter 3B and is within the set period Δt from the start time t_{3B} of the chapter B. In this case, since the chapter 2B exists before the chapter 3B, the CPU 12 determines that a chapter before the current chapter exists in the current content (step S31 in FIG. 4). Furthermore, since the playback time is within the set period Δt from the start time t_{3B} of the chapter 3B, the CPU 12 determines that the playback time of the current chapter is within the set period from the playback start time of the current chapter (step S32 in FIG. 4), selects the chapter 2B as a playback target (step S34 in FIG. 4), and starts playback from the start time t_{2B} of the chapter 2B.

On the other hand, let it be supposed that the user operates the chapter reversing button 36 when the playback time is in the playback period T_{1B} of the chapter 1B and within the set period Δt from the start time t_{1B} of the chapter 1B. In this case, no chapter before the chapter 1B exists in the content B, so that the CPU 12 determines that a chapter before the current chapter does not exist in the current content (step S31 in FIG. 4). Furthermore, since the playback time is within the set period Δt from the start time t_{1B} of the chapter 1B, the CPU 12 determines that the playback time of the current chapter is within the set period from the playback start time of the current chapter (step S35 in FIG. 4). Furthermore, the content A exists, which is to be played back before the content B, so that the CPU 12 determines that content before the current content exists (step S37 in FIG. 4), selects the chapter 1A at the beginning of the content A as a playback target (step S38 in FIG. 4), and starts playback from the start time t_{1A} of the chapter 1A.

If the user operates the chapter reversing button 36 when the playback time is in the playback period T_{1A} of the chapter 1A and not within the set period Δt from the start time t_{1A} of the chapter 1A, the CPU 12 determines that the playback time of the current chapter is not within the set period from the playback start time of the current chapter (step S35 in FIG. 4), and sets the playback time to be the start time t_{1A} of the chapter 1A.

As described above, if the user operates the chapter forwarding button 35 hen the playback time is in the playback period T_{3A} of the chapter 3A, in the DTV 11, the chapter 1B of the content B is selected as a playback target, and playback is started from the start time t_{1B} of the chapter 1B. On the other hand, if the user operates the chapter reversing button 36 when the playback time is in the playback period T_{1B} of the chapter 1B and within the set period Δt from the start time t_{1B} of the chapter 1B, in the DTV 11, the chapter 1A of the content A is selected as a playback target, and playback is started from the start time t_{1A} of the chapter 1A.

When a chapter in content before current content is selected as a playback target according to a user's operation of the chapter reversing button 36, instead of the first chapter of the previous content, the last chapter of the previous content may be selected as a playback target.

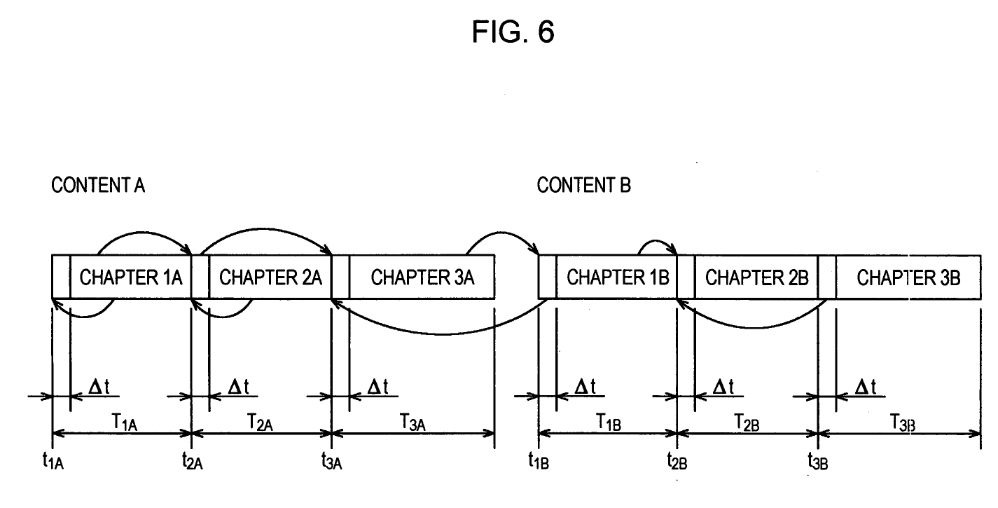

FIG. 6 is a diagram for explaining playback control in which the last chapter of content before current content is selected as a playback target.

As shown in FIG. 6, if the user operates the chapter reversing button 36 shown in FIG. 1 when the playback time is in the playback period T_{1B} of the chapter 1B and within the set period Δt from the start time t_{1B} of the chapter 1B, the CPU 12 selects the last chapter 3A of the content A as a playback target, and starts playback from the start time t_{3A} of the chapter 3A.

Except when the playback time is in the playback period T_{1B} of the chapter 1B and within the set period Δt from the start time t_{1B} of the chapter 1B, playback of content is controlled similarly to the case shown in FIG. 5.

Although each of the content A and the content B is composed of three chapters, for example, in some cases, one piece of content is composed of one chapter, i.e., content is not divided into a plurality of chapters.

If the user operates the chapter forwarding button 35 shown in FIG. 1 when current content is content not divided into chapters, a chapter in content next to the current content is selected as a playback target.

If the user operates the chapter reversing button 36 shown in FIG. 1 when current content is content not divided into chapters and the playback time is within the set period from the playback start time of the content, a chapter in content before the current content is selected as a playback target. On the other hand, if the user operates the chapter reversing button 36 shown in FIG. 1 when current content is content not divided into chapters and the playback time is not within the set period from the playback start time of the content, the playback time is set to be the start time of the current content.

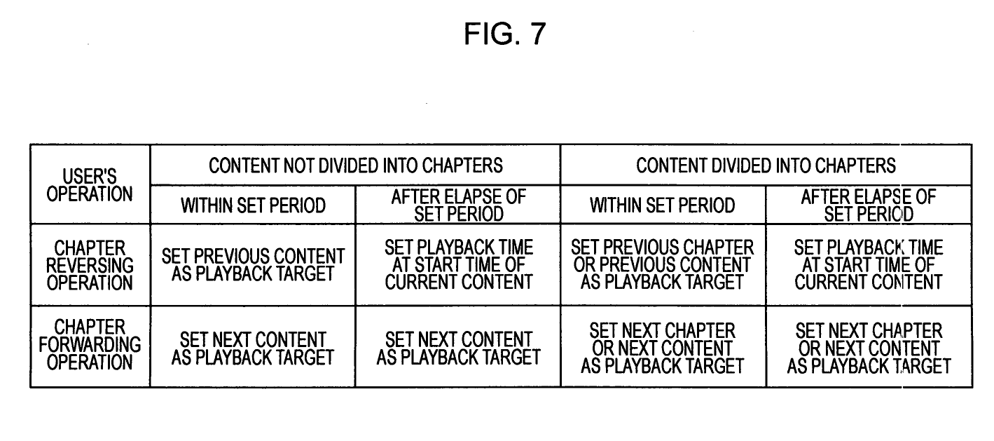

FIG. 7 shows an example of processing that is executed when the user operates the chapter forwarding button 35 or the chapter reversing button 36 in relation to content divided into chapters and content not divided into chapters as described above.

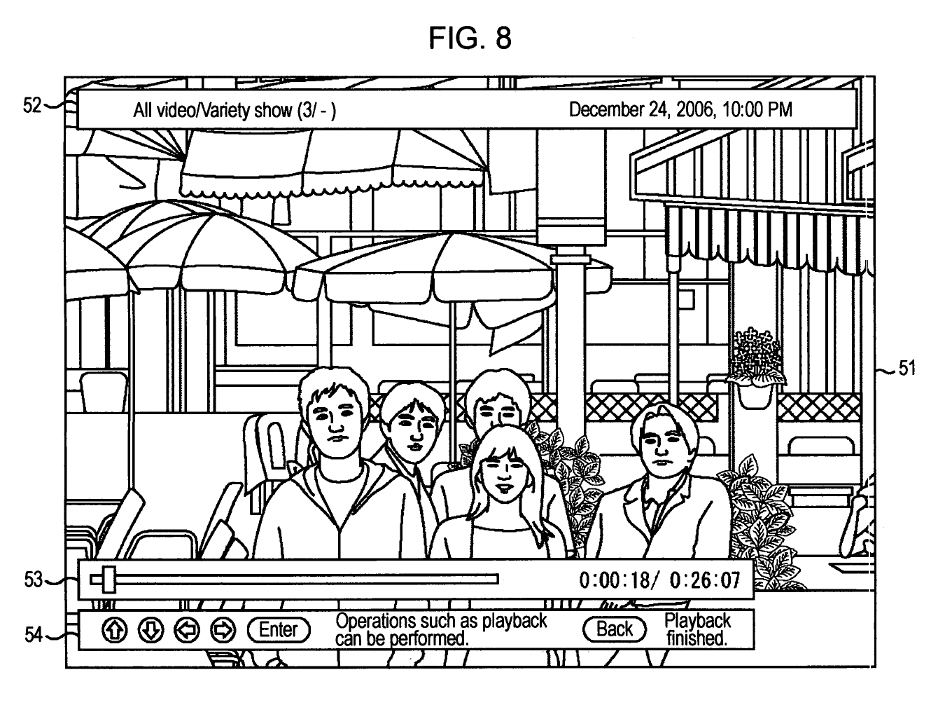

FIG. 8 is an illustration showing an example screen that is displayed on the display 22 shown in FIG. 1.

Referring to FIG. 8, in a screen 51 of the display 22, a title display section 52, a playback time display section 53, and an operation guide display section 54 are displayed.

In the title display section 52, a title of content that is currently selected as a playback target, a date and time of recording of the content, and so forth are displayed. In the playback time display section 53, a time bar in which a slider is displayed at a position corresponding to the playback time, the playback time, the time of the entire content, and so forth are displayed. In the operation guide display section 54, buttons of the remote commander 31 that can be operated by the user, description of processing that is executed when a certain button is pressed, and so forth are displayed.

For example, the user can specify whether to display or not display the title display section 52, the playback time display section 53, or the operation guide display section 54 by operating a button (not shown) of the remote commander 31.

Furthermore, in the DTV 11, when content selected as a playback target is changed according to an operation of the chapter forwarding button 35 or the chapter reversing button 36, a title of content that is newly selected as a playback target is displayed in the title display section 52 in the screen 51, so that the user can recognize that content has been changed.

Although the embodiment has been described in the context of a case where the DTV 11 plays back content stored in the storage unit 20, the DTV 11 can also play back content stored in another device connected via the communication unit 23 and a network (not shown). In this case, for example, at the DTV 11, a content list including the content stored in the another device can be created. The DTV 11 can create a content list including all the content that can be played back, or a content list in which content is grouped on the basis of individual devices storing content, and present the content list to the user.

Furthermore, the DTV 11 can create a content list in which content is classified on the basis of categories. For example, if recorded pieces of content represent individual episodes of a drama composed of a plurality of episodes that are broadcast at different times, by creating a content list for the drama as one category, the user can play back an episode before or after an episode that is currently being played back simply by operating the chapter forwarding button 35 or the chapter reversing button 36.

In the case of a playback apparatus according to the related art, for example, if the user performs a chapter forwarding operation when the last chapter of an episode is being played back, an error message indicating the absence of a next chapter is simply displayed, and the user has to perform an operation to stop playback and to specify a next episode for playback. In contrast, in the DTV 11, if the user simply performs a chapter forwarding operation when the last chapter of an episode is being played back, the next episode is played back. Thus, for example, the user does not have to perform an operation to specify a next episode for playback, so that the user can sequentially play back a plurality of episodes of a drama by a reduced burden of operation.

That is, it is possible to deal with a drama composed of a plurality of episodes as one piece of continuous content (i.e., conceptually the same as one piece of content in a playback apparatus according to the related art), so that operations involving a plurality of episodes can be performed.

A content list in which content is classified on the basis of categories can be created by the DTV 11 according to specification of a category by the user, or automatically according to meta-information of content stored in the storage unit 20. Alternatively, the DTV 11 can analyze content stored in the storage unit 20 to find preference of the user, and create, on the basis of the result of the analysis, a content list including pieces of content presumably matching the preference of the user.

In the DTV 11, as well as operations using the remote commander 31, a graphical user interface (GUI) for instructing execution of predetermined operations may be displayed on the display 22, so that the user can perform a chapter forwarding operation or a chapter reversing operation by selecting a GUI for instructing execution of a chapter forwarding operation or a chapter reversing operation.

Furthermore, when the user performs a chapter forwarding operation or a chapter reversing operation and content before or next to current content is selected as a playback target, for example, a dialog that allows the user to select whether or not to play back the content before or next to the current content may be displayed on the display 22 so that the content before or next to the current content is played back if the user selects to play back the content before or next to the current content. This prevents changing content selected as a playback target against the user's intention.

Although application of the present invention to a DTV has been described above, as well as a DTV, the present invention can be applied to, for example, a hard disk recorder, a portable music recorder (player), or other types of apparatuses that play back content.

The series of processes executed by the CPU 12 can be executed through execution of programs by the CPU 12 or by special hardware.

The programs executed by a computer (the CPU 12) can be provided as recorded on the removable medium 32, which is a package medium such as a magnetic disc (e.g., a flexible disc), an optical disc (e.g., compact disc read-only memory (CD-ROM) or a digital versatile disc (DVD)), a magneto-optical disc, or a semiconductor memory, or via a wired or wireless transmission medium, such as a local area network, the Internet, or digital satellite broadcasting.

The programs can be installed on the flash memory 15 or the storage unit 20 via the input/output interface 17 by loading the removable medium 32 on the drive 24. Alternatively, the programs can be received by the communication unit 23 via a wired or wireless transmission medium and installed on the flash memory 15 or the storage unit 20. Alternatively, the programs can be installed in advance in the ROM 13, the flash memory 15, or the storage unit 20.

The programs executed by the computer may be programs with which processes are executed sequentially in the orders described in this specification, or programs with which processes are executed in parallel or at appropriate timing such as timing of calling. Furthermore, the programs may be executed by one CPU or in a distributed manner by a plurality of CPUs.

It should be understood by those skilled in the art that various modifications, combinations, sub-combinations and alterations may occur depending on design requirements and other factors insofar as they are within the scope of the appended claims or the equivalents thereof.

What is claimed is:

1. A playback apparatus that plays back a plurality of pieces of content according to a predetermined playback order by sequentially selecting chapters included in the plurality of pieces of content as playback targets, the playback apparatus comprising:
checking means for checking, according to an operation by a user specifying, as a new playback target, a chapter in either a backward direction or a forward direction of a chapter currently selected as a playback target, whether the chapter specified by the user exists in a piece of content including the chapter currently selected as the playback target;
first determining means for determining, as a new playback target, the chapter specified by the user if it is determined that the chapter specified by the user exists in the piece of content including the chapter currently selected as the playback target; and
second determining means for determining, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

2. The playback apparatus according to claim 1, further comprising:
playback-time checking means for checking, according to a user's operation specifying, as a new playback target, a chapter in the backward direction of the chapter currently selected as the playback target, whether a playback time in the chapter currently selected as the playback target is a time after elapse of a predetermined set period from a playback start time of the chapter; and
playback-time shifting means for shifting the playback time in the chapter currently selected as the playback target to the playback start time of the chapter if it is determined that the playback time is a time after elapse of the predetermined set period from the playback start time of the chapter.

3. The playback apparatus according to claim 1, wherein when the second determining means determines, as a new playback target, a chapter included in a piece of content that is to be played back before the piece of content including the chapter currently selected as the playback target, the second determining means determines, as the new playback target, a chapter at the beginning among chapters included in the piece of content.

4. A playback method of playing back a plurality of pieces of content according to a predetermined playback order by sequentially selecting chapters included in the plurality of pieces of content as playback targets, the playback method comprising the steps of:
checking, according to an operation by a user specifying, as a new playback target, a chapter in either a backward direction or a forward direction of a chapter currently selected as a playback target, whether the chapter specified by the user exists in a piece of content including the chapter currently selected as the playback target;
determining, as a new playback target, the chapter specified by the user if it is determined that the chapter specified by the user exists in the piece of content including the chapter currently selected as the playback target; and
determining, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

5. A program for causing a computer to execute processing for playing back a plurality of pieces of content according to a predetermined playback order by sequentially selecting chapters included in the plurality of pieces of content as playback targets, the processing comprising the steps of:
checking, according to an operation by a user specifying, as a new playback target, a chapter in either a backward direction or a forward direction of a chapter currently selected as a playback target, whether the chapter specified by the user exists in a piece of content including the chapter currently selected as the playback target;
determining, as a new playback target, the chapter specified by the user if it is determined that the chapter specified by the user exists in the piece of content including the chapter currently selected as the playback target; and
determining, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.

6. A playback apparatus that plays back a plurality of pieces of content according to a predetermined playback order by sequentially selecting chapters included in the plurality of pieces of content as playback targets, the playback apparatus comprising:
a checking unit configured to check, according to an operation by a user specifying, as a new playback target, a chapter in either a backward direction or a forward direction of a chapter currently selected as a playback target, whether the chapter specified by the user exists in a piece of content including the chapter currently selected as the playback target;
a first determining unit configured to determine, as a new playback target, the chapter specified by the user if it is determined that the chapter specified by the user exists in the piece of content including the chapter currently selected as the playback target; and
a second determining unit configured to determine, as a new playback target, a chapter included in a piece of content corresponding to the chapter specified by the user among pieces of content that are to be played back according to the playback order before or after the piece of content including the chapter currently selected as the playback target, if it is determined that the chapter specified by the user does not exist in the piece of content including the chapter currently selected as the playback target.
